(19) United States
(12) Patent Application Publication
(10) Pub. No.: US 2023/0332422 A1
(43) Pub. Date: Oct. 19, 2023

(54) HEAT GENERATING FABRIC FOR CURING OUTER WALL CONCRETE AND OUTER WALL CONCRETE CURING METHOD USING SAME

(71) Applicants: Sung Man LEE, Dalseong-gun, Daegu (KR); Dong Ho Lee, Suseong-gu, Daegu (KR); Weon Cheol Song, Dalseong-gun, Daegu (KR); Dong Rae Kim, Dalseo-gu, Daegu (KR); Jeong Hwa Lee, Chilgok-gun, Gyeongsangbuk-do (KR)

(72) Inventors: Sung Man Lee, Dalseong-gun, Daegu (KR); Dong Ho Lee, Suseong-gu, Daegu (KR); Weon Cheol Song, Dalseong-gun, Daegu (KR); Dong Rae Kim, Dalseo-gu, Daegu (KR); Jeong Hwa Lee, Chilgok-gun, Gyeongsangbuk-do (KR)

(21) Appl. No.: 17/788,014

(22) PCT Filed: Jul. 21, 2020
(86) PCT No.: PCT/KR2020/009570

§ 371 Date: Jun. 22, 2022

(30) Foreign Application Priority Data
Dec. 26, 2019 (KR) 10-2019-0175345

(51) Int. Cl. E04G 21/06; D03D 1/00; D03D 15/292; D06M 11/74; D03D 13/00; D06M 15/564; D06M 15/507; D03D 15/573; D06M 23/08; D03D 15/283

(52) U.S. Cl. CPC E04G 21/06; D03D 1/00; D03D 15/292; D06M 11/74; D03D 13/004; D06M 15/564; D06M 15/507; D03D 15/573; D06M 23/08; D03D 15/283; D10B 2401/063; D10B 2505/20; D06M 2101/32

(57) ABSTRACT

A heat generating fabric for curing outer wall concrete is provided and more specifically, to a heat generating fabric for curing outer wall concrete and an outer wall concrete curing method using the same, wherein the heat generating fabric has the effects of: enabling concrete curing even in winter; having a uniform temperature distribution; having excellent flexibility, and thus excellent adhesion when applied to a concrete structure having a stepped region; having excellent heat insulating performance; enabling uniform curing even to the inside of concrete; having remarkably little change in material properties after generating heat; and having excellent durability.

### CROSS-REFERENCE TO RELATED APPLICATIONS

This application claims priority to PCT/KR2020/009570, having a filing date of Jul. 21, 2020, which claims priority to Korean Patent Application No. 10-2019-0175345, having a filing date of Dec. 26, 2019, the entire contents both of which are hereby incorporated by reference.

### FIELD OF TECHNOLOGY

The following relates to a heat generating fabric for curing outer wall concrete and, more specifically, to a heat generating fabric for curing outer wall concrete and an outer wall concrete curing method using the same, wherein the heat generating fabric has the effects of: enabling concrete curing even in winter; having a uniform temperature distribution; having excellent flexibility, and thus excellent adhesion when applied to a concrete structure having a stepped region; having excellent heat insulating performance; enabling uniform curing even to the inside of concrete; having remarkably little change in material properties after generating heat; and having excellent durability.

### BACKGROUND

Recently, as structures become taller and larger, construction is inevitable throughout the year in order to reduce the construction period and cost.

In general, in the construction of a concrete structure, concrete has cement, aggregate and water as its main constituent materials, and obtains a certain strength as it hardens by hydration of cement.

Meanwhile, if concrete does not have sufficient strength before the temperature of the concrete falls below the freezing point due to not taking appropriate thermal curing operation measures when pouring concrete in winter, moisture inside the concrete is frozen, and cracks occur in the concrete due to the pressure caused by volume expansion and moisture movement, making it impossible to continuously improve strength. Therefore, in general, the period when the average outdoor temperature is below 4° C. is set as application period of cold weather concrete, and it is stipulated that the concrete should be properly warm cured to ensure the required quality.

In particular, it is difficult to control the quality of concrete curing under extreme temperature conditions that can occur in extreme weather conditions, extreme cold regions, and mountainous regions, which are becoming a global issue, using current curing methods.

As a warm curing operation method to ensure that the concrete poured in the winter does not suffer from frost damage and exhibits the required compressive strength, conventionally, a curing method in which the periphery of the concrete pouring structure is completely surrounded using a temporary scaffold system and a waterproof tent and the inner space is heated with a lignite stove or a hot air fan has been mainly applied.

However, since in winter when the temperature is sharply low, this method not only causes a very large heat loss from the waterproof tent, which is a covering material, but also heats a large space, so it is very difficult to keep the space temperature constant, and the curing speed of concrete is not constant due to the temperature difference depending on the part inside the waterproof tent and the temperature difference between the inside and outside the concrete structure, there is a problem in that there is a difference in the degree of strength enhancement. In addition, there are cases of suffocation of workers due to smoke when using a lignite stove, and safety problems such as fire are serious.

In addition, especially during curing outer wall concrete, it was practically difficult to design so that the same desired temperature is applied to one side and the other side of the concrete structure, and it was even more difficult to design so that the same temperature is applied to the entire surface of the concrete.

There is an urgent need to develop an outer wall concrete curing method that has effects of: enabling concrete curing even in winter season; enabling applying heat at a uniform and constant temperature; enabling applying to a concrete structure having a stepped region; having excellent heat insulating performance; and enabling uniform curing even to the inside of concrete.

### SUMMARY

An aspect relates to a heat generating fabric for curing outer wall concrete and an outer wall concrete curing method using the same, wherein the heat generating fabric has the effects of: enabling concrete curing even in winter; having a uniform temperature distribution; having excellent flexibility, and thus excellent adhesion when applied to a concrete structure having a stepped region; having excellent heat insulating performance; enabling uniform curing even to the inside of concrete; having remarkably little change in material properties after generating heat; and having excellent durability.

In order to solve the above problems, embodiments of the present invention provide a heat generating fabric for curing outer wall concrete, including a carbon-based fiber that generates heat when current is applied, wherein the carbon-based fiber satisfies the following condition (1) and condition (2) at the same time:

(a²+b³)^{1/2}/c≤1.3 (1)

|a×b|/c^{1/2}≤8.3 (2)

wherein a is a fiber dimensional change ratio (%) of the carbon-based fiber, b is a thermal stress (N) of the carbon-based fiber, and c is a resistance (kΩ) of the carbon-based fiber.

According to an embodiment of the present invention, the carbon-based fiber may satisfy the following condition (1) and condition (2) at the same time:

(a²+b³)^{1/2}/c≤0.35 (1)

|a×b|/c^{1/2}≤2.3 (2)

In addition, the carbon-based fiber may have a fiber dimensional change ratio of −5% or more.

In addition, the carbon-based fiber may have a thermal stress of 5 N or less.

In addition, the carbon-based fiber may have a resistance of 10 to 500 kΩ.

In addition, when 220V AC voltage is applied, the time for which the temperature of the heat generating fabric reaches 40° C. or higher may be 30 seconds to 5 minutes.

In addition, when 220V AC voltage is applied, the time for which the temperature of the heat generating fabric reaches 70° C. or higher may be 10 minutes to 50 minutes.

In addition, when 220V AC voltage is applied, the temperature of the heat generating fabric may be 80° C. or higher after 1 hour.

In addition, the carbon-based fiber may include a fiber, and a carbon doping layer formed on at least a portion of a surface of the fiber and including a binder and carbon particles fixed to the binder.

In addition, the carbon-based fiber may have a fineness of 100 to 3,500 De.

In addition, the carbon-based fiber may have a Young's modulus of 15 to 40 g/d and an elongation of 10 to 30%.

In addition, the heat generating fabric may include at least one or more connection parts through which current flows from the outside.

In addition, embodiments of the present invention may include a warp yarn; and a weft yarn; and may include the carbon-based fiber in any one or more of the warp yarn and weft yarn.

In addition, the carbon-based fiber may be disposed in one or more strands per inch in the disposition direction of at least any one of the warp yarn and weft yarn.

In addition, the warp yarn and weft yarn may be disposed to be interwoven, or the weft yarn may be disposed above or below the warp yarn.

In addition, embodiments of the present invention may further include a ground yarn provided to weave the warp yarn and weft yarn.

In addition, the ground yarn may have a fineness of 30 to 350 De.

In addition, the ground yarn may have a melting point or softening point of 190° C. or less.

In addition, the warp yarn and weft yarn may each independently have a fineness of 100 to 3,500 De.

In addition, the warp yarn and weft yarn may each independently further include at least one selected from the group consisting of polyester fibers and conductive fibers, including at least one selected from the group consisting of a tinned copper wire, a nichrome wire, a iron chromium wire, a copper nickel wire, and a stainless wire.

In addition, embodiments of the present invention may include 1 to 60 strands of the warp yarn per inch in the warp direction and 1 to 60 strands of the weft yarn per inch in the weft direction if the warp yarn and weft yarn are disposed to be interwoven, and may include 1 to 30 strands of the warp yarn per inch in the warp direction and 1 to 30 strands of the weft yarn per inch in the weft direction if the weft yarn is disposed above or below the warp yarn.

In addition, embodiments of the present invention provides an outer wall concrete curing method, including: fixing the heat generating fabric for curing outer wall concrete described above to at least a portion of an outer wall concrete curing frame; pouring concrete into the outer wall concrete curing frame; and curing the poured concrete by applying an electric current to the heat generating fabric for curing outer wall concrete.

The heat generating fabric for curing outer wall concrete and the outer wall concrete curing method using the same according to embodiments of the present invention have the effects of: enabling concrete curing even in winter; having a uniform temperature distribution; having excellent flexibility, and thus excellent adhesion when applied to a concrete structure having a stepped region; having excellent heat insulating performance; enabling uniform curing even to the inside of concrete; having remarkably little change in material properties after generating heat; and having excellent durability.

### BRIEF DESCRIPTION

Some of the embodiments will be described in detail, with reference to the following figures, wherein like designations denote like members, wherein:

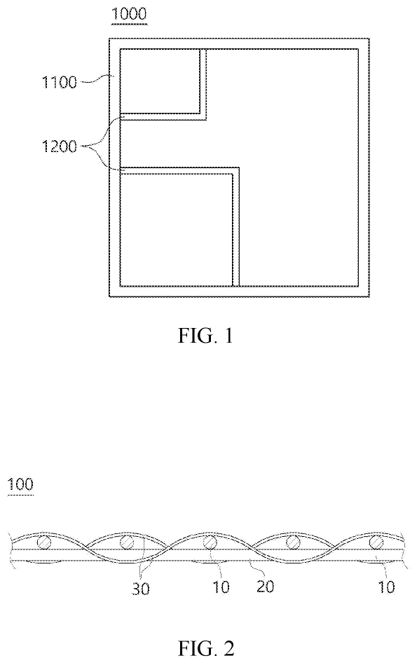

FIG. 1 is a mimetic top view showing outer and inner walls of a building;

FIG. 2 is a cross-sectional view of a heat generating fabric for curing outer wall concrete according to an exemplary embodiment of the present invention;

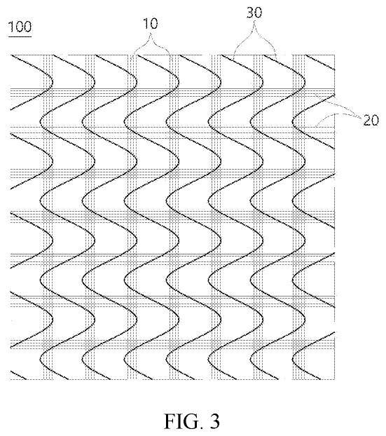

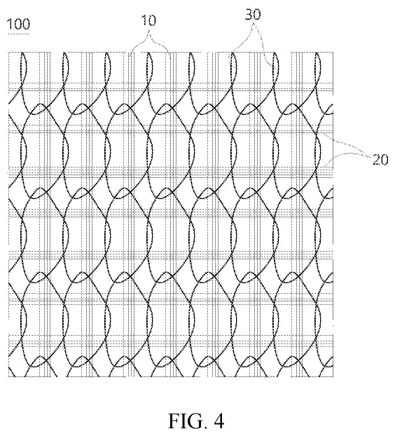

FIG. 3 is a top view showing an arrangement of a ground yarn in a heat generating fabric for curing outer wall concrete according to an exemplary embodiment of the present invention;

FIG. 4 is a top view showing an arrangement of a ground yarn in a heat generating fabric for curing outer wall concrete according to another exemplary embodiment of the present invention; and

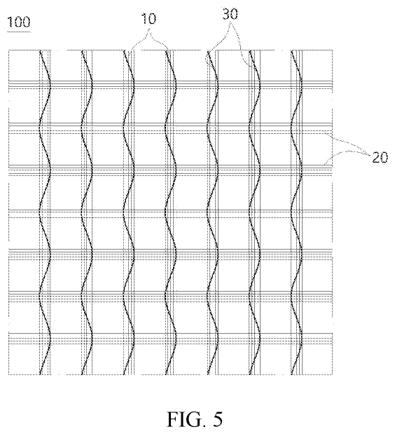

FIG. 5 is a top view showing an arrangement of a ground yarn in a heat generating fabric for curing outer wall concrete according to yet another exemplary embodiment of the present invention.

### DETAILED DESCRIPTION

Hereinafter, exemplary embodiments of the present invention will be described in detail so that those of ordinary skill in the art can readily implement embodiments of the present invention. Embodiments of the present invention may be embodied in many different forms and are not limited to the embodiments set forth herein.

Before describing the heat generating fabric for curing outer wall concrete according to embodiments of the present invention, the term ‘outer wall’ used in embodiments of the present invention will be described.

FIG. 1 is a mimetic top view showing outer and inner walls of a building, and as shown in FIG. 1, a building 1000 may include an outer wall 1100 and an inner wall 1200.

In this case, the outer wall 1100 constitutes an outer surface of the building 1000, and represents a wall surface exposed to the surface from the outside of the building 1000.

In addition, the inner wall 1200 constitutes an internal structure by dividing the interior of the building 1000, and for example, represents a wall surface dividing a floor, an inner room, a household, a room, a common facility space, and the like of the building 1000.

Meanwhile, conventionally, there was a problem in that during curing outer wall concrete, it was practically difficult to design so that the same desired temperature is applied to one side and the other side of the concrete structure, and it was even more difficult to design so that the same temperature is applied to the entire surface of the concrete. Accordingly, embodiments of the present invention sought to solve the above-mentioned problems by providing a heat generating fabric for curing outer wall concrete.

The heat generating fabric for curing outer wall concrete according to an exemplary embodiment of the present invention is implemented by including carbon-based fibers that generate heat when an electric current is applied.

Meanwhile, before describing each configuration of the heat generating fabric for curing outer wall concrete of embodiments of the present invention, the reason why the heat generating fabric for curing outer wall concrete according to embodiments of the present invention should simultaneously satisfy condition (1) and condition (2) will be described.

If the carbon-based fiber has a high fiber dimensional change ratio or a high thermal stress, there may be a problem that the change in physical properties increases after heat generation, and there may be a problem that durability is reduced. In addition, if the resistance of the carbon-based fiber is low, there may be a problem that the concrete is not cured uniformly to a desired level, and if the resistance is high, there may be a problem that heat cannot be generated to a desired level when current is applied.

Accordingly, the carbon-based fiber provided in the heat generating fabric for curing outer wall concrete according to embodiments of the present invention simultaneously satisfies the following condition (1) and condition (2).

As condition (1), (a²+b³)^{1/2}/c≤1.3, preferably (a²+b³)^{1/2}/c≤0.35; and as condition (2), |a×b|/c^{1/2}≤8.3, and preferably |a×b|/c^{1/2}≤2.3. In this case, a is a fiber dimensional change ratio (%) of the carbon-based fiber, b is a thermal stress (N) of the carbon-based fiber, and c is a resistance (kΩ) of the carbon-based fiber.

If (a²+b³)^{1/2}/c exceeds 1.3 in condition (1), or |a×b|/c^{1/2} exceeds 8.3 in condition (2), there may be a problem that the change in physical properties increases after heat generation, there may be a problem that durability is reduced, and there may be a problem that the concrete is not cured uniformly to a desired level.

Hereinafter, each configuration of the heat generating fabric for curing outer wall concrete of embodiments of the present invention will be described.

First, carbon-based fibers will be described.

The carbon-based fiber may have a fiber dimensional change ratio of −5% or more to simultaneously satisfy the above condition (1) and condition (2), and preferably, may have a fiber dimensional change ratio of −3% or more. If the carbon-based fiber has a fiber dimensional change ratio less than −5%, there may be a problem that the change in physical properties increases after heat generation, and there may be a problem that durability is reduced.

In this case, the fiber dimensional change ratio can be measured under the conditions of 100° C. and 30 minutes through KS K 0215: 2012(7.12.(1).B) standard.

In addition, the carbon-based fiber may have a thermal stress of 5 N or less to simultaneously satisfy the above condition (1) and condition (2), and preferably, may have a thermal stress of 3 N or less. If the carbon-based fiber has a thermal stress more than 5 N, there may be a problem that the change in physical properties increases after heat generation, and there may be a problem that durability is reduced.

In this case, the thermal stress can be measured under the conditions of 200° C. and 120 seconds through ASTM D 5591: 2011 standard.

And, the carbon-based fiber may have a resistance of 10 to 500 kΩ to simultaneously satisfy the above condition (1) and condition (2), and preferably, may have a resistance of 20 to 450 kΩ. If the resistance of the carbon-based fiber is less than 10 kΩ, there may be a problem that it is not cured uniformly due to heat generation exceeding a desired level, and if the resistance is more than 450 kΩ, there may be a problem that heat cannot be generated to a desired level when current is applied.

In addition, the carbon-based fiber may have a Young's modulus of 15 to 40 g/d, and preferably, may have a Young's modulus of 17 to 35 g/d. If the carbon-based fiber has a Young's modulus less than 15 g/d or a Young's modulus more than 40 g/d, as the flexibility is lowered, adhesion may be reduced when applied to a concrete structure having a stepped region, and durability may be reduced.

In addition, the carbon-based fiber may have an elongation of 10 to 30%, and preferably, may have an elongation of 15 to 25%. If the carbon-based fiber has an elongation less than 10% or an elongation more than 30%, as the flexibility is lowered, adhesion may be reduced when applied to a concrete structure having a stepped region, and durability may be reduced.

Meanwhile, since the heat generating fabric for curing outer wall concrete according to embodiments of the present invention contains carbon-based fibers, it is possible to achieve uniform curing to the inside of the concrete due to emission of far-infrared rays from the carbon-based fibers. Specifically, the carbon-based fiber may have a far-infrared emissivity of 70% or more at a wavelength of 5 to 20 μm, preferably may have a far-infrared emissivity of 80% or more at a wavelength of 5 to 20 μm, and more preferably, may have a far-infrared emissivity of 90% or more at a wavelength of 5 to 20 μm. If the carbon-based fiber has a far-infrared emissivity less than 70% at a wavelength of 5 to 20 μm, there may be a problem that uniform curing is impossible even to the inside of the concrete.

In addition, the carbon-based fiber may have a far-infrared radiation energy of 1×10² W/m²·μm or more at 30˜45° C., preferably, may have a far-infrared radiation energy of 2×10² W/m²·μm or more at 30˜45° C., and more preferably, may have a far-infrared radiation energy of 3×10² W/m²·μm or more at 30˜45° C. If the carbon-based fiber has a far-infrared radiation energy less than 1.0×10² W/m²·μm at 30˜45° C., there may be a problem that uniform curing is impossible even to the inside of the concrete.

In addition, the carbon-based fiber may have a fineness of 100 to 3,500 De, and more preferably, may have a fineness of 150 to 3,000 De. If the carbon-based fiber has a fineness less than 100 De, heat generating performance may be lowered, there may be a problem that it cannot exhibit a uniform temperature distribution, and durability may be reduced, and if it has a fineness more than 3,500 De, as the flexibility is lowered, adhesion may be reduced when applied to a concrete structure having a stepped region, and there may be a problem that it cannot exhibit a uniform temperature distribution.

Meanwhile, the carbon-based fibers are mean to include all fibers including carbon components, such as carbon fibers alone, fibers having carbon particles on at least a portion of the surface, fibers mixed with carbon fibers, fibers covered with carbon fibers, carbon fibers coated with a predetermined resin on at least a portion of the surface.

In an embodiment, the carbon-based fiber provided in the heat generating fabric for curing outer wall concrete according to the present invention may include a fiber and a carbon doping layer formed on at least a portion of the surface of the fiber.

In this case, the fiber can be used without limitation, as long as it is a fiber commonly used in the art, and the fiber may be preferably a polyester-based fiber, a polyolefin-based fiber, a polyamide-based fiber, an acrylate-based fiber, and the like, and the fiber may be more preferably a polyester-based fiber, but as long as it is a component that can satisfy the above-described physical properties of the carbon-based fiber including the carbon doping layer, it can be used without limitation, so embodiments of the present invention are not particularly limited thereto.

In addition, as the carbon doping layer may be formed through a carbon doping layer forming composition including carbon particles and a binder, the carbon doping layer may include a binder and carbon particles fixed to the binder.

The binder can be used without limitation, as long as it is a binder that can be used to fix fixed particles in general in the art, and preferably, the binder may include at least one selected from the group consisting of a natural binder, an inorganic binder, and an organic binder, and more preferably, the binder may include at least one selected from the group consisting of an inorganic binder and an organic binder, and still more preferably, the binder may include at least one selected from the group consisting of an acrylic-based binder, an urethane-based binder, a fluorine-based binder, a silicone-based binder, a styrene-based binder, an epoxy-based binder, and a phenol-based binder, and much more preferably, it may be more advantageous to use an acrylic-based binder and/or an urethane-based binder among organic binders in that the carbon-based fiber exhibits the above-described physical properties, so that the heat generating fabric for curing outer wall concrete according to embodiments of the present invention exhibits the desired effect.

In addition, the carbon particles can be used without limitation, as long as it is a carbon material that can be commonly used in the art, and preferably, the carbon particles may include at least one selected from the group consisting of carbon nanotube, graphene, carbon fiber, carbon black, amorphous graphite, flaky graphite, expanded graphite, and artificial graphite, and more preferably, it may be more advantageous to include at least one selected from the group consisting of carbon nanotube, graphene, carbon fiber, carbon black, artificial graphite, and flaky graphite in that the carbon-based fiber exhibits the above-described physical properties, so that the heat generating fabric for curing outer wall concrete according to embodiments of the present invention exhibits the desired effect.

In addition, the carbon doping layer forming composition may further include at least one selected from the group consisting of a solvent, a dispersant, a thickener, and a coupling agent.

In this case, as the solvent, dispersant, thickener and coupling agent can be used without limitation as long as they are solvents, dispersants, thickeners and coupling agents that can each be used in the art, it is not particularly limited in embodiments of the present invention.

Meanwhile, the heat generating fabric for curing outer wall concrete according to an exemplary embodiment of the present invention may include a warp yarn and a weft yarn, and may be implemented by including the carbon-based fiber in any one or more of the warp yarn and weft yarn.

Before describing the warp yarn and weft yarn of the heat generating fabric for curing outer wall concrete according to embodiments of the present invention, an arrangement width of the above-mentioned carbon-based fibers in the heat generating fabric for curing outer wall concrete will be described.

The carbon-based fiber may be included in any one or more of the warp yarn and weft yarn, preferably in both the warp yarn and weft yarn. In addition, the carbon-based fiber may be disposed in one or more strands, preferably two or more strands per inch in the disposition direction of at least any one of the warp yarn and weft yarn. If the carbon-based fiber is disposed in less than one strand per inch in the disposition direction of at least any one of the warp yarn and weft yarn, it may not have a uniform temperature distribution to a desired level, and there may be a problem that the concrete cannot be cured to the inside.

In addition, the heat generating fabric for curing outer wall concrete according to an exemplary embodiment of the present invention may further include conductive fiber in at least any one of the warp yarn and weft yarn, preferably in both the warp yarn and weft yarn. In this case, the conductive fiber and carbon-based fiber may be disposed in a total of one or more strands, preferably a total of two or more strands per inch in the disposition direction of at least any one of the warp yarn and weft yarn. If the conductive fiber and carbon-based fiber are disposed in less than a total of one strand per inch in the disposition direction of at least any one of the warp yarn and weft yarn, it may not have a uniform temperature distribution to a desired level, and there may be a problem that the concrete cannot be cured to the inside.

Meanwhile, the conductive fiber can be used without limitation, as long as it is a conductive fiber that can be commonly used in the art, and preferably, may include at least one selected from the group consisting of a tinned copper wire, a nichrome wire, an iron chromium wire, a copper nickel wire, and a stainless wire.

Hereinafter, the warp yarn, weft yarn, and heat generating fabric of the heat generating fabric for curing outer wall concrete according to embodiments of the present invention will be described.

As described above, the warp yarn may include carbon-based fibers and further include conductive fibers, and thus electrically communicate with carbon-based fibers that may be included and/or conductive fibers that may be further included in the weft yarn to be described later to express a heat generating function.

Meanwhile, the warp yarn may further include polyester fibers in addition to the carbon-based fibers and conductive fibers described above.

The warp yarn is not limited as long as it has a fineness that can be commonly used in the art, and preferably, may have a fineness of 100 to 3,500 De, and more preferably, may have a fineness of 150 to 3,000 De. If the warp yarn has a fineness less than 100 De, as heat insulating performance is lowered, there may be a problem that heat generating performance is lowered, and durability may be reduced, and if it as a fineness more than 3,500 De, as the flexibility is lowered, adhesion may be reduced when applied to a concrete structure having a stepped region.

In addition, as described above, the weft yarn may include carbon-based fibers and further include conductive fibers, and thus electrically communicate with carbon-based fibers that may be included and/or conductive fibers that may be further included in the warp yarn described above to express a heat generating function.

Meanwhile, the weft yarn may further include polyester fibers in addition to the carbon-based fibers and conductive fibers described above.

The weft yarn is not limited as long as it has a fineness that can be commonly used in the art, and preferably, may have a fineness of 100 to 3,500 De, and more preferably, may have a fineness of 150 to 3,000 De. If the weft yarn has a fineness less than 100 De, as heat insulating performance is lowered, there may be a problem that heat generating performance is lowered, and durability may be reduced, and if it as a fineness more than 3,500 De, as the flexibility is lowered, adhesion may be reduced when applied to a concrete structure having a stepped region.

In addition, the heat generating fabric may further include a ground yarn, and the ground yarn may be provided to weave the warp yarn and weft yarn.

The ground yarn can be used without limitation, as long as it is a fiber that can be commonly used in the art, and preferably, may include at least one selected from the group consisting of a nylon fiber and a PET fiber.

In addition, the ground yarn may have a lower melting point or softening point than the warp yarn and weft yarn described above, and may have a melting point or softening point of preferably 190° C. or less, and more preferably 185° C. or less. If the melting point or softening point of the ground yarn exceeds 190° C., it is impossible to selectively fuse only the ground yarn through a predetermined heat treatment, and as the warp yarn and the weft yarn may be melted or softened first, there may be a problem that a uniform temperature distribution cannot be exhibited. Accordingly, the ground yarn provided in the heat generating fabric for curing outer wall concrete may be provided in a fibrous form or may be provided as a fusion part fused through a predetermined heat treatment.

The ground yarn is not limited as long as it has a fineness that can be commonly used in the art, and preferably, may have a fineness of 30 to 350 De, and more preferably, may have a fineness of 50 to 300 De. If the ground yarn has a fineness less than 30 De, there may be a problem that the heat insulating performance cannot be expressed to a desired level, so that heat generating performance is lowered, and durability may be reduced, and if it as a fineness more than 350 De, as the flexibility is lowered, adhesion may be reduced when applied to a concrete structure having a stepped region.

Meanwhile, the heat generating fabric for curing outer wall concrete according to an exemplary embodiment of the present invention may include at least one or more connection parts to which current is applied.

The connection part can be implemented using any material that can be used as a connection part normally in the art without limitation, and preferably, may include at least one selected from the group consisting of the aforementioned carbon-based fibers and conductive fibers.

In addition, the connection part may be provided in at least one end of any one or more of the warp yarn and weft yarn, preferably at opposite ends of any one or more of the warp yarn and weft yarn, or may be separately provided outside by extending from the heat generating fabric for curing outer wall concrete.

As the heat generating fabric for curing outer wall concrete according to embodiments of the present invention includes the connection part, when current is applied, the carbon-based fiber included and/or the conductive fiber that may be further included in the heat generating fabric for curing outer wall concrete may electrically communicate with each other to express a heat generating function.

Meanwhile, in the heat generating fabric for curing outer wall concrete according to an exemplary embodiment of the present invention, when 220V AC voltage is applied, the time for which the temperature of the heat generating fabric reaches 40° C. or higher may be 30 seconds to 5 minutes, preferably 35 seconds to 4 minutes, and more preferably 45 seconds to 3 minutes. In addition, in the heat generating fabric for curing outer wall concrete according to an exemplary embodiment of the present invention, when 220V AC voltage is applied, the time for which the temperature of the heat generating fabric reaches 70° C. or higher may be 10 to 50 minutes, preferably 15 to 35 minutes. If the time for which the temperature of the heat generating fabric reaches 40° C. or higher is less than 30 seconds, or the time for which the temperature of the heat generating fabric reaches 70° C. is less than 10 minutes, as the heat generating temperature is excessive, damage to the heat generating fabric may occur and durability and mechanical properties may decrease, and if the time for which the temperature of the heat generating fabric reaches 40° C. or higher is more than 5 minutes, or the time for which the temperature of the heat generating fabric reaches 70° C. is more than 50 minutes, there may be a problem that the outer wall concrete cannot be cured to a desired level, and there may be a problem that it may not work uniformly when curing.

In addition, in the heat generating fabric for curing outer wall concrete according to an exemplary embodiment of the present invention, when 220V AC voltage is applied, the temperature of the heat generating fabric may be 80° C. or higher after 1 hour, the temperature of the heat generating fabric may preferably be 83° C. or higher after 1 hour, and the temperature of the heat generating fabric may more preferably be 85° C. or higher after 1 hour. When 220V AC voltage is applied, if the temperature of the heat generating fabric is less than 80° C. after 1 hour, there may be problems in that it may not express heat generating characteristics to a desired level, and it may not have a uniform temperature distribution to a desired level.

Meanwhile, in the warp yarn, weft yarn, and ground yarn provided in the heat generating fabric for curing outer wall concrete according to an exemplary embodiment of the present invention, the warp yarn and weft yarn may be disposed to be interwoven, and the ground yarn may be provided to weave the warp yarn and weft yarn.

First, the weave of the woven fabric may be formed by any one method selected from the group consisting of plain weave, twill weave, satin weave, and double weave.

When the plain weave, twill weave and satin weave are referred to as three basic weaves, the specific weaving method of each of the three basic weaves is subject to a typical weaving method, and on the basis of the three basic weaves, the weave may be modified or a few weaves may be mixed to obtain fancy weave. Examples of fancy plain weave include rib weave and basket weave, examples of fancy twill weave include elongated twill weave, broken twill weave, skip twill weave and pointed twill weave, and examples of derivatives of satin weave include irregular satin weave, double satin weave, extended satin weave and granite satin weave. The double weave is a fabric-weaving method in which either warp yarn or weft yarn is doubled or both of them are doubled, and the specific method thereof may be a typical weaving method of the double weave. However, it is not limited to the description of the fabric weave.

When the warp yarn and weft yarn provided in the heat generating fabric for curing outer wall concrete of embodiments of the present invention are disposed to be interwoven, and the ground yarn is provided to weave the warp yarn and weft yarn, 1 to 60 strands of the warp yarn per inch in the warp direction and 1 to 60 strands of the weft yarn per inch in the weft direction may be included, and preferably, 3 to 58 strands of the warp yarn per inch in the warp direction and 3 to 58 strands of the weft yarn per inch in the weft direction may be included. If the warp yarn is less than 1 strand per inch in the warp direction, or if the weft yarn is less than 1 strand per inch in the weft direction, as heat insulating performance cannot be expressed to a desired level, heat generating performance may be lowered, it may not have a uniform temperature distribution, the concrete may not be cured to the inside, and durability may be reduced, and if the warp yarn exceeds 60 strands per inch in the warp direction, or the weft yarn exceeds 60 strands per inch in the weft direction, as the problem of lowered flexibility and increased temperature control occurs, adhesion may be reduced when applied to a concrete structure having a stepped region.

In addition, as shown in FIG. 2, the warp yarn 10, the weft yarn 20 and the ground yarn 30 provided in the heat generating fabric 100 for curing outer wall concrete according to another exemplary embodiment of the present invention may be disposed such that the weft yarn 20 is disposed above or below the warp yarn 10, and as shown in FIGS. 2 to 5, the ground yarn 30 may be provided to weave the warp yarn 10 and the weft yarn 20.

When the weft yarn is disposed above or below the warp yarn provided in the heat generating fabric for curing outer wall concrete of embodiments of the present invention, and the ground yarn is provided to weave the warp yarn and weft yarn, 1 to 30 strands of the warp yarn per inch in the warp direction and 1 to 30 strands of the weft yarn per inch in the weft direction may be included, and preferably, 3 to 25 strands of the warp yarn per inch in the warp direction and 3 to 25 strands of the weft yarn per inch in the weft direction may be included. If the warp yarn is less than 1 strand per inch in the warp direction, or if the weft yarn is less than 1 strand per inch in the weft direction, as heat insulating performance cannot be expressed to a desired level, heat generating performance may be lowered, it may not have a uniform temperature distribution, the concrete may not be cured to the inside, and durability may be reduced, and if the warp yarn exceeds 30 strands per inch in the warp direction, or the weft yarn exceeds 30 strands per inch in the weft direction, as flexibility is lowered, adhesion may be reduced when applied to a concrete structure having a stepped region.

Meanwhile, the outer wall concrete is cured according to a curing method to be described later through the heat generating fabric for curing outer wall concrete of embodiments of the present invention.

Specifically, the outer wall concrete is cured including the steps of fixing the heat generating fabric for curing outer wall concrete to at least a portion of an outer wall concrete curing frame; pouring concrete into the outer wall concrete curing frame; and curing the poured concrete by applying an electric current to the heat generating fabric for curing outer wall concrete.

In this case, the current application may be performed to a connection part provided in at least one end of any one or more of the warp yarn and weft yarn, preferably at opposite ends of any one or more of the warp yarn and weft yarn, or separately provided outside by extending from the heat generating fabric for curing outer wall concrete, and accordingly, the carbon-based fiber included and/or the conductive fiber that may be further included in the heat generating fabric for curing outer wall concrete may electrically communicate with each other to express a heat generating function.

The heat generating fabric for curing outer wall concrete and the outer wall concrete curing method using the same according to embodiments of the present invention have the effects of: enabling concrete curing even in winter; having a uniform temperature distribution; having excellent flexibility, and thus excellent adhesion when applied to a concrete structure having a stepped region; having excellent heat insulating performance; enabling uniform curing even to the inside of concrete; having remarkably little change in material properties after generating heat; and having excellent durability.

Hereinafter, embodiments of the present invention will be described with reference to the following examples. At this time, the following examples are only presented to illustrate embodiments of the invention, and the scope of embodiments of the present invention are not limited by the following examples.

### EXAMPLES

### Example 1: Manufacture of Heat Generating Fabric for Curing Outer Wall Concrete

First, a carbon-based fiber having a fineness of 1,500 De having a carbon doping layer containing carbon particles fixed to an acrylic-based binder and an urethane-based binder on the surface of a PET fiber was prepared. In this case, the carbon-based fiber had a resistance of 370 kΩ, a far-infrared emissivity of 90.1% at a wavelength of 5 to 20 μm measured according to KCL-FIR-1005, a far-infrared radiation energy of 3.63×10² W/m²·μm at 40° C., a fiber dimensional change ratio of −1.2% measured at 100° C. and 30 minutes according to KS K 0215: 2012 (7.12.(1).B) standard, a thermal stress of 0 N measured at 200° C. and 120 seconds according to ASTM D 5591: 2011 standard, a Young's modulus of 24.57 g/d, and an elongation of 20.54% measured under the conditions of a holding distance of 250 mm and a speed of 250 mm/min through KS K 0412: 2016 (filament yarn) standard.

Then, the fabric was manufactured by supplying polyester fibers having a melting point of 260° C. and a fineness of 1,000 De as a warp yarn, supplying polyester fibers having a melting point of 260° C. and a fineness of 1,000 De as a weft yarn in which the carbon-based fibers are disposed in three strands per inch in the weft disposition direction and the weft yarn passes under the warp yarn, and supplying LM fibers having a melting point of 170° C. and a fineness of 75 De as a ground yarn to weave the warp yarn and weft yarn as shown in FIG. 4, and by disposing tinned copper wires which are conductive fibers as a connection part at opposite ends of the warp yarn. At this time, 15 strands of warp yarn were disposed per inch in the warp direction, and 15 strands of weft yarn were disposed per inch in the weft direction. Then, the fabric was heat-treated at a temperature of 320° C. for 1 second to fusion-bond the ground yarn to manufacture a heat generating fabric for curing outer wall concrete.

### Examples 2 to 19 and Comparative Examples 1 to 7

Heat generating fabric for curing outer wall concrete was manufactured in the same manner as in Example 1, except that the fiber dimensional change ratio, thermal stress, resistance, fineness, Young's modulus, elongation, type, number of strands per inch and inclusion or not, and the like of the carbon-based fiber were changed according to Tables 1 to 5.

### Experimental Example 1

1. Measuring the Time to Reach 40° C.

After applying 220V AC voltage to the heat generating fabric for curing outer wall concrete manufactured according to the Examples and Comparative Examples, temperatures of 10 random points on the heat generating fabric for curing outer wall concrete were measured, the average of these was calculated, and the time for the average value of temperature to reach 40° C. was measured, and then shown in Tables 1 to 5 below.

2. Temperature Measurement after 1 Hour when 220V AC Voltage is Applied

After 1 hour when applying 220V AC voltage to the heat generating fabric for curing outer wall concrete manufactured according to the Examples and Comparative Examples, temperatures of 10 random points on the heat generating fabric for curing outer wall concrete were measured, the average of these was calculated, and the average value of the temperature was measured and shown in Tables 1 to 5 below.

3. Durability Assessment

With respect to the heat generating fabric for curing outer wall concrete manufactured according to the Examples and Comparative Examples, a total of 100 sets of tensioning and restoring 10% of the initial length in the weft direction were performed. At this time, durability was assessed by marking ∘ if there is no abnormality, and marking X if any problem occurs, such as if any one of warp yarn, weft yarn, ground yarn, and carbon-based fiber is detached, single yarn occurs, and heat quantity decreases.

### Experimental Example 2

After bonding the heat generating fabric for curing outer wall concrete manufactured in the Examples and Comparative Examples with the width and length of 2,000 mm×3,000 mm to be bonded to a partition of a gang form body, to the gang form body consisting of a tetrahedron without top and bottom, the size of one side is 2,500 mm×3,000 mm×3 mm in width, length and thickness, the concrete was cured for 9 hours at minus 10° C., and then the following physical properties were measured and shown in Tables 1 to 5 below.

1. Concrete Curing Uniformity Assessment

For each of the cured concrete, sensory assessment was performed on the uniformity of concrete curing by 10 persons with more than 15 years of experience in the relevant field for any 20 points on the concrete, and the uniformity of concrete curing was assessed by marking ⊚ if the concrete is cured at all 20 points, marking ∘ if the concrete is cured at 18 or more points and less than 20 points, marking Δ if the concrete is cured at 15 or more points and less than 18 points, and marking × if the concrete is cured at less than 15 points.

2. Heat Generating Performance Assessment

When the concrete is cured, after 90 minutes of applying 220V AC voltage, the temperature of the gang form and the attached iron plate was measured to assess the heat generating performance.

In this case, a high temperature indicates that the heat generating performance is excellent, and a low temperature indicates that the heat generating performance is deteriorated.

3. Concrete Internal Curing Assessment

After dividing each of the cured concrete in half in the vertical direction, a sensory assessment was performed on the uniformity of concrete curing by 10 people with more than 15 years of experience in the relevant field for the central part, and this was assessed through a 7-point scale, and then the average value was measured to assess the degree of curing inside the concrete.

4. Assessment of Change Rate of Tensile Strength of Fabric

Before curing the concrete, initial tensile strength in each of the warp and weft directions of the fabric was measured; and after curing the concrete, the tensile strength in each of the warp and weft directions of the fabric was measured, and then the rate of change in tensile strength compared to the initial tensile strength in each of the warp and weft directions was measured, and the average value was calculated. In this case, the rate of change of tensile strength was assessed by marking ∘ if the rate of change of tensile strength after curing compared to initial tensile strength is less than ±1%, marking Δ if ±1 to ±5%, and marking × if more than ±5%.

### Experimental Example 3

After bonding the heat generating fabric for curing outer wall concrete manufactured in the Examples and Comparative Examples to a gang form body manufactured in a stepped shape so that a facet of 3,000 mm×4,000 mm×3 mm in width, length and thickness on one side has a height difference of 30 cm, such that the heat generating fabric covers the upper surface of the gang form body, the following physical properties were measured and shown in Tables 1 to 5 below.

1. Adhesion Assessment

After curing the concrete for 9 hours at 10° C. below zero through the gang form body to which the heat generating fabric for curing outer wall concrete manufactured in the Examples and Comparative Examples is bonded, for each of the cured concrete, sensory assessment was performed on the uniformity of concrete curing by 10 persons with more than 15 years of experience in the relevant field for any 20 points on the concrete, and adhesion was assessed through the uniformity of concrete curing by marking ⊚ if the concrete is cured at all 20 points, marking ∘ if the concrete is cured at 18 or more points and less than 20 points, marking Δ if the concrete is cured at 10 or more points and less than 18 points, and marking × if the concrete is cured at less than 10 points.

TABLE 1

| | | Example | Example | Example | Example | Example | Example |
|---|---|---|---|---|---|---|---|
| Classification | | 1 | 2 | 3 | 4 | 5 | 6 |
| Carbon- | Fiber dimensional | −1.2 | −2.9 | −6.4 | −1.8 | −2.4 | −1.3 |
| based | change ratio (%) | | | | | | |
| fiber | Thermal stress (N) | 0 | 0.7 | 1.6 | 2.6 | 6.1 | 0 |
| | Resistance (kΩ) | 370 | 382 | 398 | 379 | 396 | 5 |
| | Condition (1) | 0.0032 | 0.0077 | 0.017 | 0.012 | 0.039 | 0.26 |
| | Condition (2) | 0 | 0.10 | 0.51 | 0.24 | 0.73 | 0 |
| | Fineness (De) | 1500 | 1500 | 1500 | 1500 | 1500 | 1500 |
| | Young's modulus | 24.57 | 24.66 | 24.31 | 24.64 | 24.18 | 24.51 |
| | (g/d) | | | | | | |
| | Elongation (%) | 20.54 | 20.55 | 20.56 | 20.54 | 20.56 | 20.48 |
| | Arrangement width | 3 | 3 | 3 | 3 | 3 | 3 |
| | (number of strands | | | | | | |
| | per inch) | | | | | | |

| | | | | | | |
|---|---|---|---|---|---|---|
| Whether ground yarn is | ◯ | ◯ | ◯ | ◯ | ◯ | ◯ |
| included | | | | | | |
| Time to reach 40° C. when | 2 minutes | 2 minutes | 2 minutes | 2 minutes | 2 minutes | within 30 |
| 220 V AC voltage is applied | 43 seconds | 50 seconds | 56 seconds | 47 seconds | 54 seconds | seconds |
| Heat generating fabric | 87 | 86 | 79 | 87 | 81 | 94 |
| temperature (° C.) after | | | | | | |
| 1 hour | | | | | | |
| Durability assessment | ◯ | ◯ | X | ◯ | X | ◯ |
| Concrete curing | ⊚ | ⊚ | ⊚ | ⊚ | ⊚ | Δ |
| uniformity assessment | | | | | | |
| Heat generating | 63 | 63 | 62 | 63 | 62 | 100 or |
| performance assessment | | | | | | more |
| (° C.) | | | | | | |
| Concrete internal curing | 6.8 | 6.7 | 6.7 | 6.8 | 6.7 | 2.1 |
| assessment | | | | | | |
| Assessment of change | ◯ | ◯ | Δ | ◯ | Δ | Δ |
| rate of tensile strength | | | | | | |
| of fabric | | | | | | |
| Adhesion assessment | ⊚ | ⊚ | ⊚ | ⊚ | ⊚ | Δ |

TABLE 2

| | | Example | Example | Example | Example | Example | Example |
|---|---|---|---|---|---|---|---|
| Classification | | 7 | 8 | 9 | 10 | 11 | 12 |
| Carbon- | Fiber dimensional | −1.3 | −1.2 | −1.2 | −2.4 | −2.9 | −1.0 |
| based | change ratio (%) | | | | | | |
| fiber | Thermal stress (N) | 0 | 0 | 0 | 3 | 2.7 | 0 |
| | Resistance (kΩ) | 20 | 450 | 550 | 20 | 20 | 320 |
| | Condition (1) | 0.065 | 0.0027 | 0.0022 | 0.29 | 0.27 | 0.0031 |
| | Condition (2) | 0 | 0 | 0 | 1.61 | 1.8 | 0 |
| | Fineness (De) | 1500 | 1500 | 1500 | 1500 | 1500 | 50 |
| | Young's modulus | 24.55 | 24.81 | 24.67 | 24.67 | 24.68 | 39.12 |
| | (g/d) | | | | | | |
| | Elongation (%) | 20.52 | 20.56 | 20.61 | 20.56 | 20.55 | 10.89 |
| | Arrangement width | 3 | 3 | 3 | 3 | 3 | 3 |
| | (number of strands | | | | | | |
| | per inch) | | | | | | |

| | | | | | | |
|---|---|---|---|---|---|---|
| Whether ground yarn is | ◯ | ◯ | ◯ | ◯ | ◯ | ◯ |
| included | | | | | | |
| Time to reach 40° C. when | 40 seconds | 3 minutes | 4 minutes | 2 minutes | 2 minutes | over 5 |
| 220 V AC voltage is applied | | 17 seconds | | 51 seconds | 52 seconds | minutes |
| Heat generating fabric | 89 | 83 | 68 | 86 | 86 | 60 |
| temperature (° C.) after | | | | | | |
| 1 hour | | | | | | |
| Durability assessment | ◯ | ◯ | ◯ | ◯ | ◯ | X |
| Concrete curing | ⊚ | ⊚ | Δ | ⊚ | ⊚ | X |
| uniformity assessment | | | | | | |
| Heat generating | 75 | 52 | 43 | 62 | 61 | 31 |
| performance assessment | | | | | | |
| (° C.) | | | | | | |
| Concrete internal curing | 6.6 | 6.3 | 5.5 | 6.6 | 6.5 | 2.7 |
| assessment | | | | | | |
| Assessment of change | ◯ | ◯ | ◯ | ◯ | ◯ | ◯ |
| rate of tensile strength | | | | | | |
| of fabric | | | | | | |
| Adhesion assessmment | ⊚ | ⊚ | Δ | ⊚ | ⊚ | Δ |

TABLE 3

| | | Example | Example | Example | Example | Example | Example |
|---|---|---|---|---|---|---|---|
| Classification | | 13 | 14 | 15 | 16 | 17 | 18 |
| Carbon- | Fiber dimensional | −1.2 | −2.7 | −2.9 | −2.3 | −1.3 | −1.1 |
| based | change ratio (%) | | | | | | |
| fiber | Thermal stress (N) | 0 | 1.2 | 1.8 | 0 | 0 | 0.9 |
| | Resistance (kΩ) | 330 | 350 | 300 | 370 | 370 | 370 |
| | Condition (1) | 0.0036 | 0.0086 | 0.013 | 0.0062 | 0.0035 | 0.0038 |
| | Condition (2) | 0 | 0.17 | 0.30 | 0 | 0 | 0.051 |
| | Fineness (De) | 150 | 3000 | 4000 | 1500 | 1500 | 1500 |
| | Young's modulus | 32.33 | 20.68 | 15.21 | 10.96 | 17.84 | 34.68 |
| | (g/d) | | | | | | |
| | Elongation (%) | 17.96 | 23.47 | 27.35 | 35.18 | 24.41 | 15.78 |
| | Arrangement width | 3 | 3 | 3 | 3 | 3 | 3 |
| | (number of strands | | | | | | |
| | per inch) | | | | | | |

| | | | | | | |
|---|---|---|---|---|---|---|
| Whether ground yarn is | ◯ | ◯ | ◯ | ◯ | ◯ | ◯ |
| included | | | | | | |
| Time to reach 40° C. when | 3 minutes | 2 minutes | 2 minutes | 2 minutes | 2 minutes | 2 minutes |
| 220 V AC voltage is applied | 27 seconds | 44 seconds | 49 seconds | 55 seconds | 46 seconds | 44 seconds |
| Heat generating fabric | 86 | 85 | 80 | 81 | 82 | 82 |
| temperature (° C.) after | | | | | | |
| 1 hour | | | | | | |
| Durability assessment | ◯ | ◯ | ◯ | X | ◯ | ◯ |
| Concrete curing | ⊚ | ⊚ | Δ | ⊚ | ⊚ | ⊚ |
| uniformity assessment | | | | | | |
| Heat generating | 60 | 62 | 59 | 62 | 63 | 62 |
| performance assessment | | | | | | |
| (° C.) | | | | | | |
| Concrete internal curing | 6.4 | 6.6 | 5.7 | 6.6 | 6.7 | 6.6 |
| assessment | | | | | | |
| Assessment of change | ◯ | ◯ | ◯ | ◯ | ◯ | ◯ |
| rate of tensile strength | | | | | | |
| of fabric | | | | | | |
| Adhesion assessment | ⊚ | ⊚ | X | ⊚ | ⊚ | ⊚ |

TABLE 4

| | | | | Com- | Com- | Com- |
|---|---|---|---|---|---|---|
| | | | | para- | para- | para- |
| | | | | tive | tive | tive |
| | | Ex- | Ex- | Ex- | Ex- | Ex- |
| | | ample | ample | ample | ample | ample |
| Classification | | 19 | 20 | 1 | 2 | 3 |
| Carbon- | Fiber | −1.0 | −1.2 | −4 | −6.1 | −6.8 |
| based | dimensional | | | | | |
| fiber | change | | | | | |
| | ratio (%) | | | | | |
| | Thermal | 2.6 | 0 | 6.8 | 6.7 | 6.7 |
| | stress (N) | | | | | |
| | Resistance | 370 | 370 | 11 | 15 | 13 |
| | (kΩ) | | | | | |
| | Condition | 0.012 | 0.0032 | 1.65 | 1.23 | 1.43 |
| | (1) | | | | | |
| | Condition | 0.14 | 0 | 8.2 | 10.55 | 12.64 |
| | (2) | | | | | |
| | Fineness | 1500 | 1500 | 1500 | 1500 | 1500 |
| | (De) | | | | | |
| | Young's | 45.10 | 24.57 | 23.60 | 23.52 | 22.83 |
| | modulus | | | | | |
| | (g/d) | | | | | |
| | Elongation | 5.71 | 20.54 | 20.80 | 20.94 | 21.15 |
| | (%) | | | | | |
| | Arrangement | 3 | 0.5 | 3 | 3 | 3 |
| | width | | | | | |
| | (number | | | | | |
| | of strands | | | | | |
| | per inch) | | | | | |

| | | | | | |
|---|---|---|---|---|---|
| Whether ground | ◯ | ◯ | ◯ | ◯ | ◯ |
| yarn is included | | | | | |
| Time to reach 40° C. | 2 | over 5 | 3 | 3 | 3 |
| when 220 V AC | min- | min- | min- | min- | min- |
| voltage is applied | utes | utes | utes | utes | utes |
| | 44 | | 1 | 12 | 30 |
| | sec- | | sec- | sec- | sec- |
| | onds | | onds | onds | onds |
| Heat generating | 83 | 62 | 77 | 78 | 75 |
| fabric temperature | | | | | |
| (° C.) after 1 hour | | | | | |
| Durability | X | ◯ | X | X | X |
| assessment | | | | | |
| Concrete curing | ⊚ | Δ | ⊚ | ⊚ | ⊚ |
| uniformity | | | | | |
| assessment | | | | | |
| Heat generating | 62 | 35 | 62 | 62 | 60 |
| performance | | | | | |
| assessment (° C.) | | | | | |
| Concrete internal | 6.1 | 3.2 | 6.7 | 6.6 | 6.4 |
| curing assessment | | | | | |
| Assessment | ◯ | ◯ | X | X | X |
| of change | | | | | |
| rate of tensile | | | | | |
| strength of fabric | | | | | |
| Adhesion assessment | X | Δ | ⊚ | ⊚ | ⊚ |

TABLE 5

| | | Com- | Com- | Com- |
|---|---|---|---|---|
| | | parative | parative | parative |
| | | Example | Example | Example |
| Classification | | 4 | 5¹⁾ | 6²⁾ |
| Carbon- | Fiber dimensional | — | — | — |
| based | change ratio (%) | | | |
| fiber | Thermal stress (N) | — | — | — |
| | Resistance (kΩ) | — | 0.2 | 0.00005 |
| | Condition (1) | — | — | — |
| | Condition (2) | — | — | — |
| | Fineness (De) | — | 1500 | 1500 |
| | Young's modulus | — | — | — |
| | (g/d) | | | |
| | Elongation (%) | — | — | — |
| | Arrangement width | — | 3 | 3 |
| | (number of strands | | | |
| | per inch) | | | |

| | | | |
|---|---|---|---|
| Whether ground yarn is | ◯ | ◯ | ◯ |
| included | | | |
| Time to reach 40° C. when | — | within 30 | within 30 |
| 220 V AC voltage is | | seconds | seconds |
| applied | | | |
| Heat generating fabric | — | 90 | 93 |
| temperature (° C.) after 1 | | | |
| hour | | | |
| Durability assessment | ◯ | X | X |
| Concrete curing | X | ◯ | X |
| uniformity assessment | | | |
| Heat generating | −9 | 100 or | 100 or |
| performance assessment | | more | more |
| (° C.) | | | |
| Concrete internal curing | 1.6 | 4.3 | 1 |
| assessment | | | |
| Assessment of change | ◯ | X | X |
| rate of tensile strength of | | | |
| fabric | | | |
| Adhesion assessment | X | ◯ | X |

¹⁾Comparative Example 5 indicates that nichrome wire is used instead of carbon-based fiber.
²⁾Comparative Example 6 indicates that the PET fiber and the binder were not included, and carbon fiber was used alone.

As can be seen from Tables 1 to 5 above, Examples 1, 2, 4, 7, 8, 10, 11, 13, 14, 17, and 18 satisfying all of the fiber dimensional change ratio, thermal stress, resistance, fineness, Young's modulus, elongation, type, number of strands per inch, inclusion or not, and the like of the carbon-based fiber according to embodiments of the present invention, compared to Examples 3, 5, 6, 9, 12, 15, 16, 19, 20 and Comparative Examples 1 to 6, in which any one of them was omitted, show that the time to reach 40° C. is faster, the temperature of the heat generating fabric rises higher after 1 hour when AC voltage is applied, the durability and uniformity of curing of concrete are more excellent, the change rate of the tensile strength of the fabric is lower, and as heat generating performance and heat insulating performance are more excellent and at the same time the flexibility is more excellent, adhesion is more excellent and uniform curing is possible even to the inside of concrete.

Although the invention has been illustrated and described in greater detail with reference to the preferred exemplary embodiment, the invention is not limited to the examples disclosed, and further variations can be inferred by a person skilled in the art, without departing from the scope of protection of the invention.

For the sake of clarity, it is to be understood that the use of “a” or “an” throughout this application does not exclude a plurality, and “comprising” does not exclude other steps or elements.

1. A heat generating fabric for curing outer wall concrete comprising:
a carbon-based fiber that generates heat when current is applied, wherein the carbon-based fiber satisfies the following condition (1) and condition (2) at the same time:
(a²+b³)^{1/2}/c≤1.3, (1)

|a×b|/c^{1/2}≤8.3, (2)
wherein a is a fiber dimensional change ratio (%) of the carbon-based fiber, b is a thermal stress (N) of the carbon-based fiber, and c is a resistance (kΩ) of the carbon-based fiber.

2. The heat generating fabric for curing outer wall concrete of claim 1, wherein the carbon-based fiber satisfies the following condition (1) and condition (2) at the same time:
(a²+b³)^{1/2}/c≤0.35, (1)

|a×b|/c^{1/2}≤2.3. (2)

3. The heat generating fabric for curing outer wall concrete of claim 1, wherein the carbon-based fiber has a fiber dimensional change ratio of −5% or more.

4. The heat generating fabric for curing outer wall concrete of claim 1, wherein thermal stress is 5 N or less.

5. The heat generating fabric for curing outer wall concrete of claim 1, wherein the resistance is 10 to 500 kΩ.

6. The heat generating fabric for curing outer wall concrete of claim 1, wherein, when 220V AC voltage is applied, a time for which a temperature of the heat generating fabric reaches 40° C. or higher is 30 seconds to 5 minutes.

7. The heat generating fabric for curing outer wall concrete of claim 1, wherein, when 220V AC voltage is applied, a time for which a temperature of the heat generating fabric reaches 70° C. or higher is 10 minutes to 50 minutes.

8. The heat generating fabric for curing outer wall concrete of claim 1, wherein, when 220V AC voltage is applied, a temperature of the heat generating fabric is 80° C. or higher after 1 hour.

9. The heat generating fabric for curing outer wall concrete of claim 1, wherein the carbon-based fiber comprises:
a fiber, and
a carbon doping layer formed on at least a portion of a surface of the fiber and comprising a binder and carbon particles fixed to the binder.

10. The heat generating fabric for curing outer wall concrete of claim 1, wherein the carbon-based fiber has a fineness of 100 to 3,500 De.

11. The heat generating fabric for curing outer wall concrete of claim 1, wherein the carbon-based fiber has a Young's modulus of 15 to 40 g/d and an elongation of 10 to 30%.

12. The heat generating fabric for curing outer wall concrete of claim 1, further comprising at least one or more connection parts through which current flows from an outside.

13. The heat generating fabric for curing outer wall concrete of claim 1, comprising:
a warp yarn; and
a weft yarn;
wherein the carbon-based fiber is comprised in any one or more of the warp yarn and the weft yarn.

14. The heat generating fabric for curing outer wall concrete of claim 13, wherein the carbon-based fiber is disposed in one or more strands per inch in a disposition direction of at least any one of the warp yarn and the weft yarn.

15. The heat generating fabric for curing outer wall concrete of claim 13, wherein the warp yarn and the weft yarn are disposed to be interwoven, or the weft yarn is disposed above or below the warp yarn.

16. The heat generating fabric for curing outer wall concrete of claim 15, further comprising a ground yarn provided to weave the warp yarn and the weft yarn.

17. The heat generating fabric for curing outer wall concrete of claim 16, wherein the ground yarn has a fineness of 30 to 350 De.

18. The heat generating fabric for curing outer wall concrete of claim 13, wherein the warp yarn and the weft yarn each independently have a fineness of 100 to 3,500 De.

19. The heat generating fabric for curing outer wall concrete of claim 15, comprising 1 to 60 strands of the warp yarn per inch in a warp direction and 1 to 60 strands of the weft yarn per inch in a weft direction if the warp yarn and the weft yarn are disposed to be interwoven, and
comprising 1 to 30 strands of the warp yarn per inch in a warp direction and 1 to 30 strands of the weft yarn per inch in the weft direction if the weft yarn is disposed above or below the warp yarn.

20. An outer wall concrete curing method, comprising:
fixing the heat generating fabric for curing outer wall concrete according to claim 1 to at least a portion of an outer wall concrete curing frame;
pouring concrete into the outer wall concrete curing frame; and
curing the poured concrete by applying an electric current to the heat generating fabric for curing outer wall concrete.
